(19) United States
(12) Patent Application Publication
(10) Pub. No.: US 2015/0032945 A1
(43) Pub. Date: Jan. 29, 2015

(54) METHOD FOR FLASH COMPRESSED INSTRUCTION CACHING FOR LIMITED RAM/FLASH DEVICE ARCHITECTURES

(71) Applicant: Stefano Marconcini, Palo Alto, CA (US)

(72) Inventor: Stefano Marconcini, Palo Alto, CA (US)

(73) Assignee: THOMSON LICENSING, Issy de Moulineaux (FR)

(21) Appl. No.: 14/367,191

(22) PCT Filed: Jan. 29, 2012
(86) PCT No.: PCT/CN2012/070731

§ 371 Date: Jun. 19, 2014

(51) Int. Cl. G06F 12/08; G06F 12/02

(52) U.S. Cl. CPC G06F 12/0875; G06F 12/0246; G06F 12/0862; G06F 2212/7203; G06F 2212/6028; G06F 2212/452
USPC 711/103

(57) ABSTRACT

Compression and the caching of decompressed code in RAM is described by using an uncompressed paged instruction caching fault method to keep all of code compressed in a FLASH memory. The method only decompresses and caches in DRAM memory the portion of code that is miming at a certain instance in time (i.e., DRAM window), which maintains a pre-fetched portion of code based on static windowing FLASH.

### BACKGROUND

1. Technical Field

The concepts presented relate to memory management. More particularly it relates to a method for Fast Low-Latency Access with Seamless Handoff (FLASH) caching in devices having a finite Random Access Memory (RAM)/FLASH memory capacity.

2. Related Art

RAM and FLASH memory tend to be very limited in many older set top boxes (STB). Examples of the typical STB memory resource availability on legacy products have FLASH components up to 4 MB of storage and RAM components up to 16 MB of storage, which such memories are typically shared, and are possibly partitioned on different bus interfaces, between video memory and applications (such as Middleware, Drivers, Control Access and Graphical User Interface).

Current methods of caching and memory management are typically hardware or software approaches to optimize code instruction access times based on different level of RAM access by different components in a device.

The lack of memory in an STB because a problem when accommodating a large program instruction set where the physical option of adding more RAM or FLASH memory may be difficult and expensive for legacy STBs. The requirement of providing more memory for a large program instruction set limits the return of investment done by a Network Provider (i.e., service provider) when either requiring the addition of memory for old STBs or replacing such STBs entirely with new devices. On the other hand, if the software in a STB cannot be upgraded due to the cost incurred by a service provider for a new STB, the service provider is likely to lose customers to other service providers who have better STBs and software.

### SUMMARY

An implementation of the presented concepts allows for legacy STBs or other devices that have limited NOR-FLASH and Dynamic Random Access Memory (DRAM) memory capability to handle the operations of caching into and out of the limited memory of such STBs.

This and other aspects of the present concepts are achieved in accordance with an embodiment of the invention where the method for memory management in a device includes the steps of caching uncompressed code from a FLASH memory in the device to a DRAM in the device, maintaining code compressed in FLASH memory, and caching decompressed code in DRAM during a predetermined window of time during the start up of the device.

According to an exemplary embodiment, the caching of uncompressed code in a device can include dimensioning of the DRAM memory area for the uncompressed code, and applying a pass operation at a compilation time to generate executable code from the DRAM cache of the device. The application of the pass operation includes restructuring the executable code by embedding one or more jump operations to the run-time support of the device, assimilating pages of code resident in certain areas of the FLASH memory to FLASH blocks of the FLASH memory, building runtime support tables, and building compressed code and prefetchable pages.

In accordance with an exemplary embodiment, an apparatus having a memory management system includes a processor, a FLASH memory coupled to the processor, and a DRAM memory coupled to the processor. The processor is configured to cache decompressed code from the FLASH memory to the DRAM memory and maintain compressed code in the FLASH memory such that caching of the decompressed code in DRAM is performed during a predetermined time window.

These and other aspects, features and advantages of the present principles will become apparent from the following detailed description of exemplary embodiments, which is to be read in connection with the accompanying drawings.

### BRIEF DESCRIPTION OF THE DRAWINGS

FIG. 1 is high level flow diagram of the method for memory caching in devices having limited memory according to an implementation of the invention;

FIG. 2 is a more detailed flow diagram of the method for memory caching in devices having limited memory according to an implementation of the invention;

FIG. 3 is another more detailed flow diagram of the method for memory caching in devices having limited memory according to an implementation of the invention;

FIG. 4 is a flow diagram of the parser aspect of the method for memory caching in devices having limited memory according to an implementation of the invention

FIG. 5 is a diagram representing an exemplary implementation of the first step of FIG. 1 showing the method for caching uncompressed code from Flash to RAM;

FIG. 6 is a diagram representing an example of the method for maintaining code compressed in flash and the caching of un-decompressed code in DRAM window;

FIG. 7 is a block diagram of a set top box (STB) architecture to which the presented concepts can be applied; and

FIG. 8 is a block diagram of an alternative set-top-box (STB) architecture to which the presented concepts can be applied.

### DETAILED DESCRIPTION

The present principles in the present description are directed to memory management in a FLASH/RAM environment, and more specifically to STBs having a finite amount of FLASH/RAM available. It will thus be appreciated that those skilled in the art will be able to devise various arrangements that, although not explicitly described or shown herein, embody the present principles and are included within the scope of the described arrangements.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the diagrams presented herein represent conceptual views of illustrative circuitry embodying the present principles. Similarly, it will be appreciated that any flow charts, flow diagrams, state transition diagrams, pseudocode, and the like represent various processes which can be substantially represented in computer readable media and so executed by a computer or processor, whether or not such computer or processor is explicitly shown.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage.

Other hardware, conventional and/or custom, can also be included. Similarly, any switches shown in the figures are conceptual only. Their function can be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. Thus, any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

Some presented embodiments assist with the compression and caching of decompressed code in RAM. That is, some of the presented concepts are based on software (without any HW support) where an uncompressed paged instruction caching fault is used to keep code compressed in FLASH where portions of the code is decompressed and cached in a DRAM at certain instance in time (i.e., DRAM window/predetermined period of time).

Additional embodiments explain how to maintain compressed code in FLASH memory and copy and maintain a small uncompressed Instruction cache in DRAM, so that code is not duplicated in RAM and occupancy/access ratio is maintained stable and optimized.

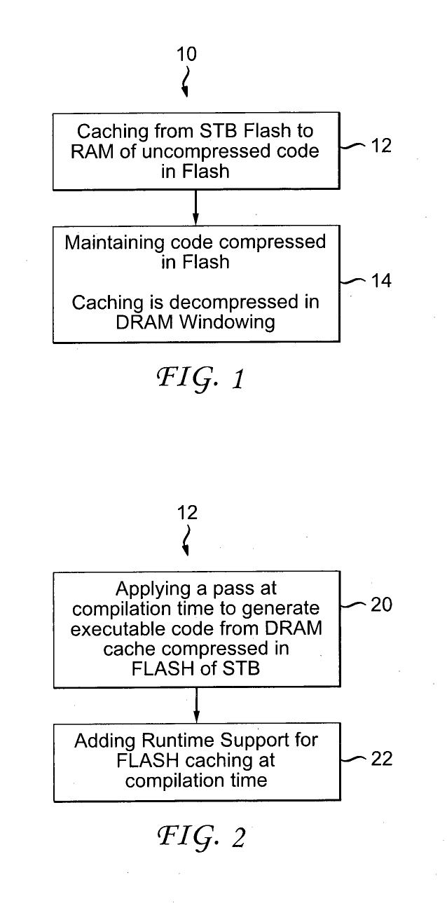

Referring to FIG. 1, the first step (12) is to describe a method of caching code from a STB FLASH memory to RAM of uncompressed code in FLASH. This operation is performed for the purpose of saving DRAM memory during the execution of the STB Operating system and applications.

The second step (14) maintains the code compressed in the FLASH memory and code is decompressed directly in DRAM whereby such decompressed code is cached. Hence, by modifying the manner in which STBs deal with memory management as suggested by the first step (12), the second step (14) provides a method for maintaining instruction code on Flash compressed, to fit more STB code in the FLASH memory as well.

As referred to herein the new method will be called out as MICP-FLASH (“software”/Memory Instruction Compressed Paging for FLASH). By way of example, the concepts herein are described in the context of a STB Decoder Architecture; however those of skill in the art will recognize the illustrative concepts presented can apply to other hardware architectures.

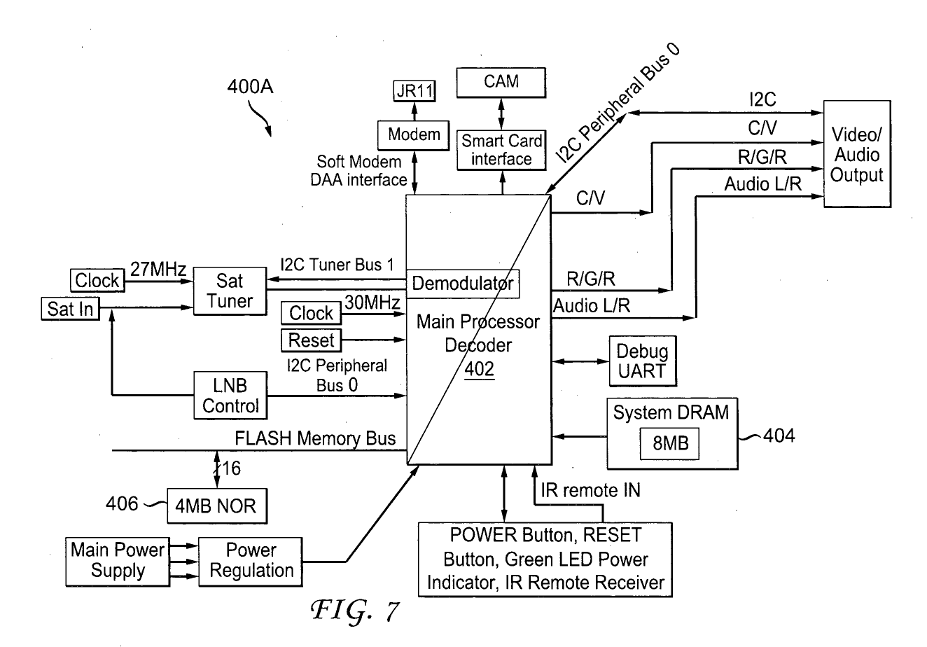

In legacy STBs, such as the exemplary STB 400 shown in FIG. 7, FLASH components are NOR FLASH 406, as an exemplary form of memory. NOR FLASH 406 allows random access in read mode and is used to run code out of it, basically as a slower DRAM memory 404 on the memory bus of the decoder processor 402.

Code compression in FLASH and copy execution in RAM has become increasing used as a strategy to save FLASH memory, however random accessibility is lost as a device cannot run compressed code. That is, code needs to be decompressed in RAM and executed, as a monolithic array of instructions, out of RAM.

The limited use of FLASH characteristics would not be such a big problem, if there were enough available DRAM to acquire a whole copy of a decompressed program without a loss in performance, but DRAM is typically limited due to the cost of such a memory.

The main component of the decoder is the 402 processor core. Older generation STB Decoder architectures [e.g. ST55xx] are based on two principles. First, architecture will provide resources that are to be used in parallel, such as Decoder, I/O, and Core. Secondly, the details of the architecture are exposed to allow for flexibility in the way these resources are used.

The model of STB processor 402 consists of a simple pipelined Reduced Instruction Set Computing (RISC) or Very Long Instruction Word (VLIW) core (e.g. MIPS32 or ST5517), separate data and instruction memories and programmable busses to interface DRAM, FLASH, Electrically Erasable Programmable Read-Only Memory (EEPROM) memory models. Many of the complicated features found in modern microprocessors like a Memory Management Unit (MMU) and segmentation/pagination are not implemented in hardware in a legacy STB system. This requires the compiler to implement and customize these features as needed for a specific program and specific needs and thus, no automatic, off the shelf solution can be used.

Since new STB Middleware and Applications require more storage than is allowed by the designed hardware (including local processor cache, Flash and RAM), some mechanism is needed to load new data from external FLASH into DRAM memory while not wasting DRAM with a full copy of uncompressed data but leaving most of FLASH data in a compressed form. In effect, some of the DRAM memory 404 can be used as cache of blocks for compressed code sitting in the slower and architecturally different NOR FLASH memory storage space 406.

One method for resolving this caching behavior is to add a run time support at compilation time after a static code analysis step, which manages buffering of compressed pages in DRAM. Then such pages can be decompressed from the compressed cache buffer to the cache buffer of allocated DRAM. This decompressed code can then be used for code execution whereby such code stays in the FLASH until the next loading from FLASH. Note that decompression of compressed cache buffers is managed using the same cache buffers the cache support in DRAM uses to run code at run time.

In the present exemplary implementation of the invention, the logical hardware abstraction module comprises a code portion of a FLASH image (typically 2.5-3.5 MB on legacy STB) that when such image is compressed would presumably be in the order of 50% of the original code size, based on current compression algorithms, 1 DRAM Buffer for in-place decompression of the predefined blocks and execution of code, and the flat memory model of the STB Core Processor not supporting hardware caching.

Exemplary software components and hardware with a typical FLASH usage on MPEG2 decoders with current software features require 1.5 MB for Middleware code, 200 KB of Variables, 256 KB for boot loader, 940 KB for UI apps stored in FLASH (e.g., 640 KB Guide+Messaging App. 100 KB+VOD app. 200 KB), 256 KB for FLASH File System used by the Middleware; and 1.2 MB for Drivers' code.

For RAM usage, typical values are 4 MB for Video and OSD memory (at standard resolution and MPEG2 compression requirements), 5 MB for Event Data for the Guide, and, 5.5 MB for OS, Middleware and other Drivers' requirements.

Those of ordinary skill in the art will recognize that the above data easily shows the requirement for code compression in FLASH, but the non feasibility of buffering the entire decompressed code base in RAM, unless trimming of data caching on an ad-hoc bases is done. However, such an aspect would cause a detriment of the user experience, especially for Guide and other UI data that requires caching in RAM from the stream, as data acquisition is slow.

According to the exemplary embodiment, the steps for MICP-FLASH applied to Legacy STB Architectures are divided into two portions:

1) The first step is to describe a method for caching from STB Flash to RAM of uncompressed code in Flash which includes dimensioning of the memory area for the uncompressed page set (step 12, FIG. 1); and

2) The second step is to solve the issue of maintaining the code compressed in Flash and caching of decompressed code in DRAM windowing (step 14, FIG. 1).

Those of skill in the art will recognize that it is a basic requirement that the MICP-FLASH can provide an acceptable response time to the user experience of the STB, especially during cache misses.

All methods found in existing literature are applied to Parallel Machines with very small first stage SRAM memory for caching (a few 10 KBs) and networked DRAM, or between two levels of RAM in general purpose computers, but not applied to FLASH-DRAM couple and compression, to solve space issues on STB architectures with customizations for TV viewing performance sustainability.

Referring to FIG. 2, a pass operation (for example, a software pass) is applied at compilation time to generate executable code from a STB DRAM cache that remains compressed in the NOR FLASH of the STB (20). The application of compression to code to save FLASH space and the mapping/customization of the algorithm to the STB HW and SW architecture, including Middleware, Drivers and interpreted code can be applied. Once the pass operation is performed, the runtime support can be added for FLASH caching at compilation time (22).

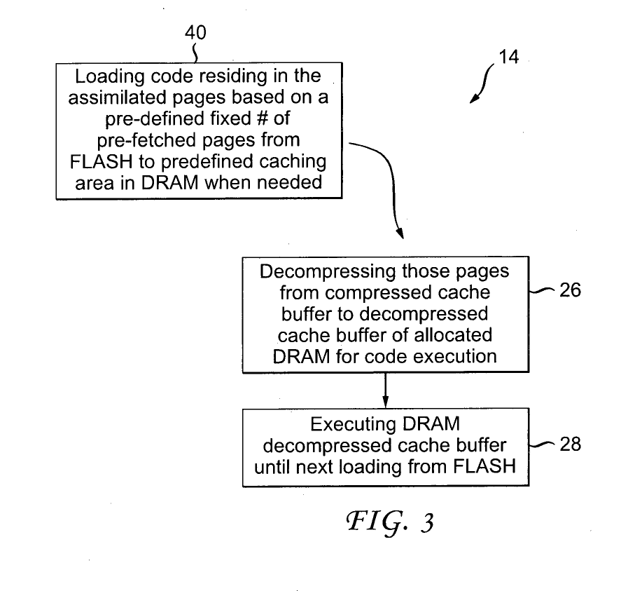

FIG. 3 shows a high level flow diagram of the steps that make up step 14 of FIG. 1 for maintaining code compressed in FLASH. Step 14 includes the loading of code residing in the assimilated pages based on pre-defined fixed number of pre-fetched pages from FLASH to the predefined caching are in DRAM when needed (step 40). This loading operation (40) can be made up of additional steps, where the first step decompresses those pages from the compressed cache buffer to the decompressed cache buffer of the allocated DRAM for code execution (26). Once performed, the code is executed from the DRAM decompressed cache buffer until the next loading from FLASH (28). As stated before, the buffer decompression of instructions from the FLASH to DRAM is the same DRAM buffer from where a specific page of instructions execution, taken from the DRAM cache pool.

In a STB, the instruction cache can be defined as static, fixed size, pagination of the compiled flash instruction stream. The pages of code that would, in a standard STB architecture, reside in a certain area of the NOR FLASH, can be assimilated to the flash blocks of the FLASH component (i.e. typically 128 KB or 256 KB). The code residing in those pages, compressed from the original compiled and uncompressed instruction stream would then be loaded, based on a predefined fixed number pre-fetched pages, from FLASH to the predefined caching area in DRAM of the STB when they are needed. The main problem is the space that the code takes in FLASH and DRAM, specific dimension for compressed page set and DRAM for caching needs to be defined.

According to the present disclosure, the dimensioning of a memory area for uncompressed page set, R, is provided as follows:

DRAM instruction cache area is dependent and multiple of the page size of flash, z, representing some size, (e.g. 128 Kbytes), hence dependent on the FLASH component chosen;

The total dimension of the cacheable program, Y, represents a size of the total dimension (for example, 3.5 MB, considering at most ⅔ of the total size of the uncompressed code size of 5.2 MB as per example above);

sis is the ratio between the number of m pages of FLASH and n pages of RAM assigned for the calculation. m/n;

The RAM cache of instruction pages could be placed in FLASH if not enough RAM is available;

As a result: s·n·z=m·z=Y, R=n·z where z is fixed by the FLASH chip of choice and the optimal dimension of R (optimal from the point of view of speed vs. user response) can be found, varying n in [1 . . . m] based on the specific STB program run.

For example, for a total size of 3.5 MB of code, at most, R, e.g. 1 MB of DRAM would be dedicated to hold uncompressed instruction cache pages. Assuming in a STB software stack when the locality of instructions is high pages will be needed more than once, allowing such pages to be retrieved from the DRAM cache after the first use for many hits.

In the STB, the software caching code, static and runtime support for choosing which page needs to be loaded in DRAM, uncompressing the code, and remapping instruction onto DRAM cache, will be integrated into the program by a MICP-FLASH parser after the last stage of linking the STB program.

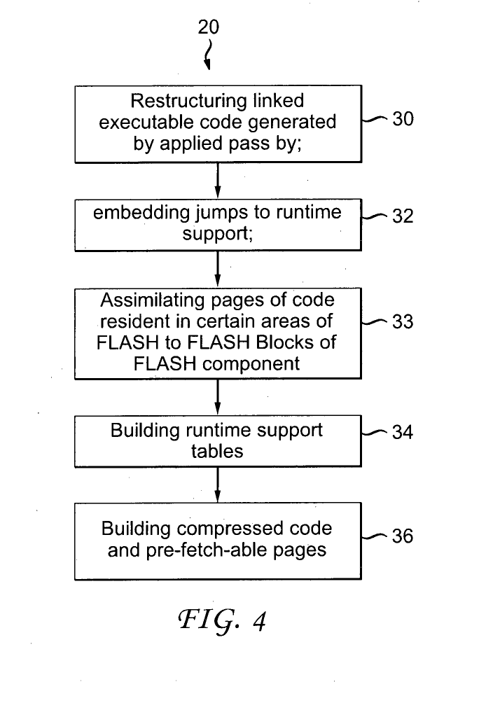

The MICP-FLASH parser will add the runtime support functions (step 22, FIGS. 2 and 4) for FLASH caching, whereby an operation will check\ to see if a certain page is resident in the cache. If such a page is missing in the DRAM cache, code is loaded and decompress whereby the decompressed code is then executed. Although there can appear to be similarities to the tag checking, data fetch and pre-fetch performed by an on-chip instruction hardware cache, one assumes that on legacy STBs being operated, there will be no applicable HW caching support that would otherwise allow to save memory space (e.g., NOR FLASH and/or DRAM).

The MICP-FLASH parser can insert jumps operations to the run-time support of the instruction decompressor and caching at specific calculated points when the upcoming code is not resident in the DRAM cache. In locations where the parser calculates the code, such code is predicted to be resident in cache already, and the program can simply continue without jumping to the runtime support.

The runtime support of cache is always resident in a separate area of the DRAM cache and is not unloaded (or can be residing in a separate area of FLASH from which it executes). As long as the STB Decoder Core Processor executes code within the page, the STB program does not need to check to see if the next code is present. The STB program will definitely need jump operations to the runtime support when instruction flows outside the specific FLASH page.

Referring to FIG. 4, an exemplary method is shown for the MICP-FLASH parser. The exemplary method restructures the linked executable code (in step 30) that maps to an exemplary STB architecture. The exemplary method is defined by:

embedding jump operations to the run-time support at specific points where jump instructions change the sequential flow of control of the STB program (step 32);

when the MICP-FLASH parser has performed the above step, jump instructions to the runtime support, already placed in DRAM or FLASH, can be added, by assimilating pages of code resident in certain areas of FLASH to FLASH blocks in the FLASH component (step 33);

building runtime support tables for mapping Original Base addressing, Block Size (Page Size) and Compressed Block Size (step 34); and

building compressed code and pre-fetchable pages (usually more than one) (step 36);

when the full executable runs (step 14—See FIG. 3), the code residing in the assimilated pages is loaded (40) based on the pre-defined fixed number of pre-fetched pages from FLASH to predefined caching area in the DRAM when needed. This step is actually performed by the RunTime Support itself as shown in FIG. 3 (Step 14), which includes the steps 26 and 28.

As will be understood by those of skill in the art, the MICP-FLASH parser can operate with the actual machine instruction set of the processor code of the STB decoder. Pass 1 and possibly the following passes should be, than, implemented modifying the compiler driver for the specific processor used, and used as the final passes of the new compiler final compilation pass. The final new pass should be applied to STB assembly language where all the possible optimizations and macro expansions are already taking place.

Pass 1: (FIG. 4—step 20)

Pass 1 deals with all existing JUMP and Conditional Branch instructions from the original machine instruction generated code, modifying the code base inserting jumps to the MICP Runtime Support routine when necessary, that is when the original address is a jump outside the current at the page size, and passing the parameters depending on the type of jump as explained below:

A Pass 1/Jump substitution procedure depends on the specific assembly language of the STB core processor taken into consideration, however for the basic Jump instructions, the basic operations by the MICP-FLASH pass 1 will be:

If the original codebase finds a JUMP command to an instruction location: The JUMP instruction is modified with a jump operation to the MICP-FLASH Runtime Support passing the instruction location as parameter.

If the original codebase finds a Jump operation to an instruction location based on a register value and a Jump operation back from subroutine: The JUMP instruction is modified with a jump to the MICP-FLASH Runtime Support passing the register contents as parameters.

Pass 1 Branch Instructions substitution procedure: If the original codebase finds a Branch operations the pass will replace a branch with a BRANCH command and a JUMP operation to the MICP-FLASH Runtime Support passing two different target locations for the MICP-FLASH to jump to.

### Pass 2: (FIG. 4—Step 33)

Pass 2 procedure: The entire program of the STB decoder generated by the compiler after Pass 1 (that is after steps 30, 32) is logically divided into Pages of Page Size dimension (calculated as above stated) and, as it is passed, the code is modified substituting every last instruction of a Page with a Processor JUMP Instruction at the address of FLASH location where the MICP Runtime Support has been previously placed (this step is similar to Pass 1 but only performed at code page limits). The actual address (Next Virtual Program Counter) is passed to the MICP runtime Support Routine for it to find the next Page to load at run time.

### Pass 3: (FIG. 4—Step 34 and 36)

Pass 3 procedure: this procedure deals with compression and storage of compressed code into FLASH pages of half size of the original code, Page size modified via Pass 1 and 2. The only requirement, apart from speed for the compression procedure to be used, is that Pass 3 must not be using additional DRAM for decompression (a Lempel-Ziv-Oberhumer (LZO) procedure can be used for this compression pass and also by the MIPC-FLASH Runtime Support for decompression of the Pages from FLASH to DRAM Cache). Pass 3 will then compress all Pages one by one (of Page Size, z), build a FLASH table of Compressed Pages of Page Size, z.

At execution time, the STB code will be loaded into DRAM from the start address, this means at least the first Page of the Compressed Page table, resulting from Pass 3 needs to be loaded, decompressed, stored in DRAM and a jump to the first original instruction needs to be performed. We say at least as, pre-fetching of multiple pages can be easily implemented by the Run Time support just looking at the last instruction of the Page and also load in cache the next sequential page (or multiple, just looking at multiple pages) This is done passing the start address to the MIPC-Runtime Support routine. The routing will take the first Page, decompress it and store it in the first position of the cache. The cache is accessed as a Hash Table (HASH Function) and as such, the original address of the first instruction of the Page, the address passed to the MIPC-Runtime Support is also stored in the cache for checking if the real code Page is loaded or not.

The MIPC-Runtime Support will then jump to DRAM and start executing the code from the first position. The first address position should be chosen different from zero to minimize hits on Hash (address)=0.

The code will execute until the next jump to the MIPC-Runtime Support with the next address. The MIPC-Runtime Support is in charge of calculating HASH (address) and check if in the DRAM Code cache a Page starting with the original start address (e.g. most significant bits not considering the first i bits of the address (2i=z where z is the Page Size) passed to the routine, exists or not (Address/m pages, where m is the number of Compressed Pages in FLASH). The Page will exist in cache if the memorized original address (Start of a Page address or Page Base Address) is equal to the one passed to the MIPC-Runtime Support routine after taking the most 32-i bits of the address (Address Mod m, where m is the number of Compressed Pages in FLASH).

If the Address matches, the Runtime Routine will jump to the start of Cache address of that page+less i less significant bits of the Address passed to the routine.

If the Address does not match, the Runtime Routine will need to load the compressed Page out of FLASH sitting in the table at position Address/m although the block will be half of the size of the original uncompressed one.

The routine will then decompress the block and store the result in DRAM Cache in position HASH (Page Base Address), storing there the Page Base Address itself also. If the position is occupied, the position will be overwritten by the new content (this manages multiple hits of the HASH function used). As all the addresses can be collected and can be known at compile time during Pass 1 and 2, a Perfect Hash Function can be found to avoid multiple hits assuming the n Pages in DRAM is known and fixed at compile time.

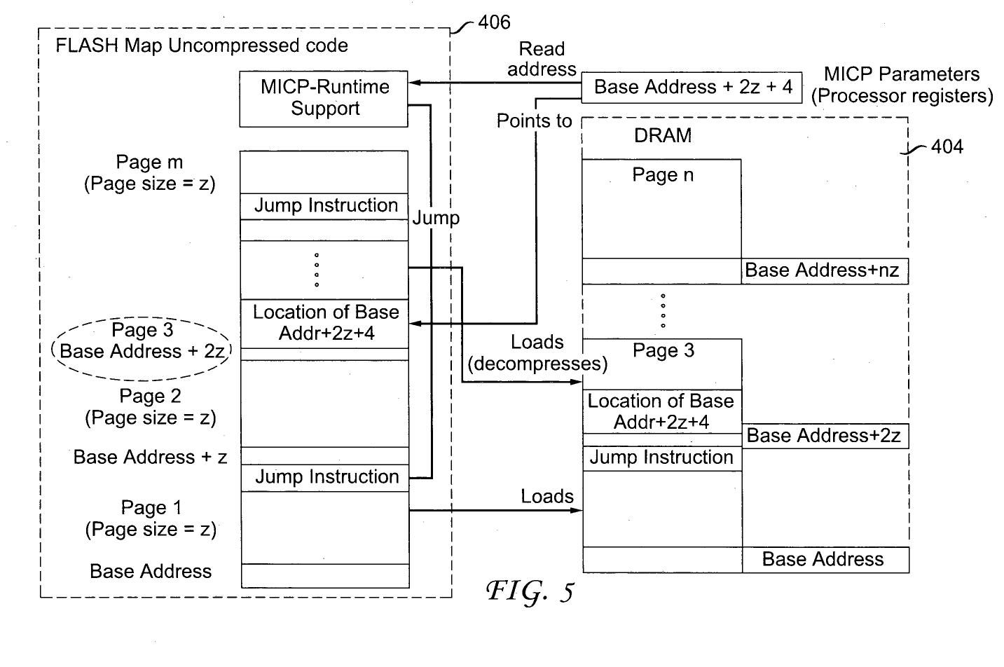

FIG. 5 shows an example of the process of caching uncompressed code from FLASH to RAM according to an exemplary implementation of the invention. In the example of a not compressed case, Page 1 code runs from DRAM and one Jump instruction jumps to Page 3 at an internal address (Base Address+2x+4). MICP-RS loads the address from a register and finds Base Address+2z into DRAM using Division and HASH (BaseAddress+2z). If the page is not there, the MICP-RS loads it in DRAM and jumps to the right address, continuing the STB code run.

In the example of a compressed case (i.e., the code is compressed in FLASH), the load operation will involve a local decompression of the page.

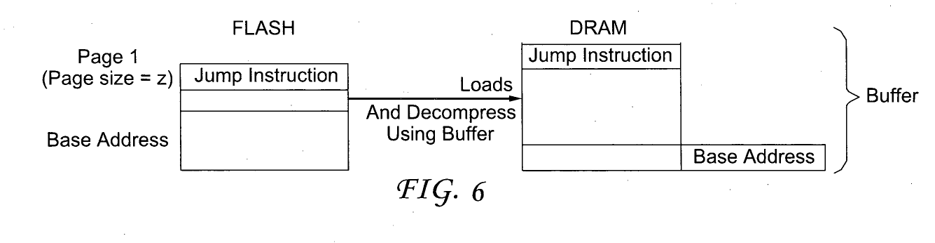

FIG. 6 shows an example where the code is maintained compressed in FLASH having a dimension of <50% of the uncompressed code in DRAM. The decompression of the code will happen in the same DRAM buffer where the final code page will reside at the end of the decompression before any code can run and any JUMP command can be executed with MICP-RS support.

An exemplary embodiment adds specifics of the STB architecture, NOR FLASH characteristics and code compression in FLASH and applies to any instruction set STB Program compilation of legacy decoders.

In general, this is an application of software instruction caching and compression and it is applicable to all Set Top Box architectures or small legacy devices where NOR FLASH and DRAM are becoming the bottleneck for upgrades of new features.

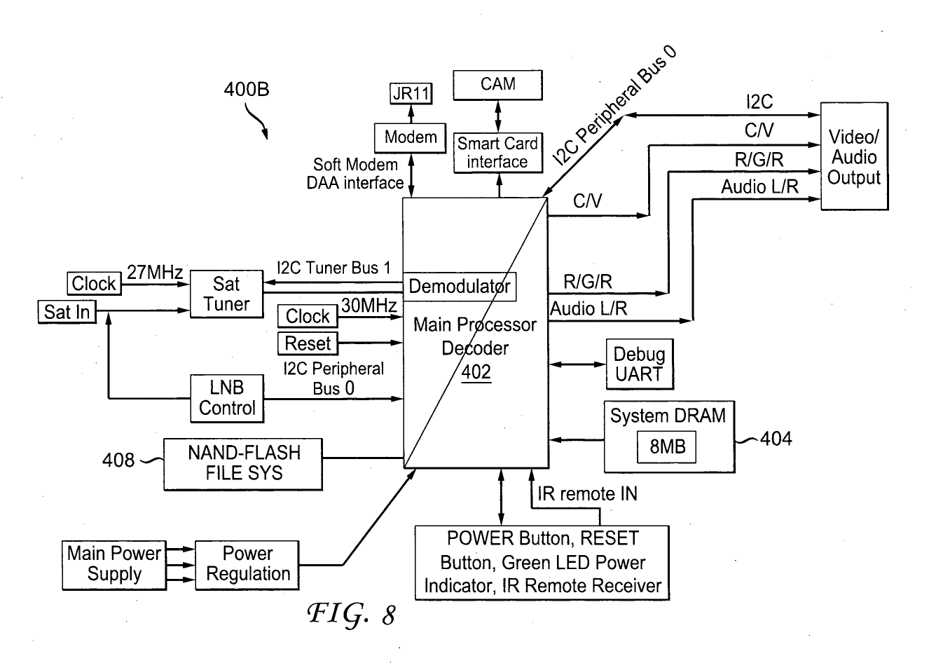

In addition to NOR FLASH Legacy STB applications, the described principles can be applied to STB architectures using NAND-FLASH devices that do not have memory mapped direct access for read/write operations, but need to be interfaced by a NAND-FLASH File System. FIG. 8 shows an example where the NAND-FLASH filed system 408 is not memory mapped for direct access. In this case the MICP Runtime Support for reading and writing in/out of flash to DRAM needs to be modified to interface the device related NAND-FLASH File System Application Program Interface (API). Those of ordinary skill in the art will recognize that this interface with the API of the NAND-FLASH file system can take many different forms, depending on the requirements of such an implementation. This modification to the invention makes it applicable to new STB architectures and thus, not only limited to the application of the invention to legacy STBs.

These and other features and advantages of the present principles can be readily ascertained by one of ordinary skill in the pertinent art based on the teachings herein. It is to be understood that the teachings of the present principles can be implemented in various forms of hardware, software, firmware, special purpose processors, or combinations thereof.

Most preferably, the teachings of the present principles are implemented as a combination of hardware and software. Moreover, the software can be implemented as an application program tangibly embodied on a program storage unit. The application program can be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform can also include an operating system and microinstruction code. The various processes and functions described herein can be either part of the microinstruction code or part of the application program, or any combination thereof, which can be executed by a CPU. In addition, various other peripheral units can be connected to the computer platform such as an additional data storage unit and a printing unit.

It is to be further understood that, because some of the constituent system components and methods depicted in the accompanying drawings are preferably implemented in software, the actual connections between the system components or the process function blocks can differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications can be effected therein by one of ordinary skill in the pertinent art without departing from the scope of the present principles. All such changes and modifications are intended to be included within the scope of the present principles as set forth in the appended claims.

1. A method for memory management in a device, the method comprising the steps of:
caching uncompressed code from a FLASH memory in the device to a Dynamic Random Access Memory (DRAM) in the device (12);
maintaining compressed code in said FLASH (14); and
caching said uncompressed code in DRAM during a period of time while starting up said device (14).

2. The method of claim 1, wherein said caching uncompressed code (12) comprises:
dimensioning of the DRAM memory area for the uncompressed code (20); and
applying a pass operation at a compilation time to generate executable code from the DRAM cache.

3. The method of claim 2, wherein the applying a pass operation (20) restructures the executable code, said pass operation further comprises:
embedding one or more jumps to run-time support (32);
assimilating pages of code resident in certain areas of FLASH to FLASH blocks of the FLASH component (33);
building runtime support tables (34); and
building compressed code and prefetchable pages (36).

4. The method of claim 3, wherein said maintaining code compressed in FLASH (14) step further comprises:
loading code residing in the assimilated pages based on a predefined fixed number of prefetched pages from said FLASH to a predefined caching area in said DRAM (40).

5. The method of claim 4, wherein said loading (40) further comprises:
decompressing pages from a compressed cache buffer to a decompressed cache buffer of allocated DRAM for code execution (26); and
executing code contained in the DRAM decompressed cache buffer until a next loading of code from FLASH (28) is performed.

6. The method of claim 2, wherein said caching decompressed code (12) in DRAM further comprises:
adding runtime support for FLASH caching upon a compilation time (22).

7. The method of claim 2, wherein said caching decompressed code (12) in DRAM further comprises:
adding runtime support for FLASH caching upon compilation time, wherein said added runtime support includes the step of interfacing with a NAND-FLASH file system application program interface.

8. An apparatus having memory management features, the apparatus comprising:
a processor (402);
a FLASH memory (406) coupled with the processor; and
a DRAM memory (404) coupled with the processor,
wherein the processor is configured to can needed uncompressed code from the FLASH memory to the DRAM memory during a predetermined time window and to otherwise maintain compressed code in the FLASH memory.

9. The apparatus of claim 8, wherein said FLASH memory comprises NOR FLASH.

10. The apparatus of claim 8, wherein said predetermined time window is during a compilation stage of the apparatus.

11. An apparatus having memory management capability, the apparatus comprising:
means for caching uncompressed code from a FLASH memory in the device to a DRAM in the device;
means for maintaining code compressed in FLASH; and
means for caching decompressed code in DRAM during a predetermined window of time during start up of the device.

12. The apparatus of claim 11, wherein said means for caching uncompressed code further comprises:
means for dimensioning of the DRAM memory area for the uncompressed code (20); and
means for applying a pass at compilation time to generate executable code from the DRAM cache.

13. The apparatus of claim 11, wherein said means for applying a pass further comprises:
means for restructuring the executable code, said means for restructuring further comprising,
means for embedding one or more jumps to run-time support;
means for assimilating pages of code resident in certain areas of FLASH to FLASH blocks of the FLASH component;
means for building runtime support tables; and
means for building compressed code and pre-fetchable pages.

14. The apparatus of claim 12, wherein said means for maintaining code compressed in FLASH (14) further comprises means for loading code residing in the assimilated pages based on a pre-defined fixed number of pre-fetched pages from FLASH to predefined caching area in DRAM.

15. The apparatus of claim 14, wherein said means for loading further comprises:
means for decompressing pages from a compressed cache buffer to a decompressed cache buffer of allocated DRAM for code execution; and
means for executing code contained in the DRAM decompressed cache buffer until next loading from FLASH.

16. The apparatus of claim 11, wherein said means for caching decompressed code in DRAM further comprises means for adding runtime support for FLASH caching upon compilation time.
